(19) United States
(12) Patent Application Publication
(10) Pub. No.: US 2010/0151820 A1
(43) Pub. Date: Jun. 17, 2010

(54) Devices, Systems and Methods for Localized and Controlled Telephone Service

(75) Inventors: Pepper Mulherin, Evansville, IN (US); Kenneth A. Skupien, Chicago, IL (US); Daniel G. Ruiz, New Braunfels, TX (US)

Correspondence Address: AT&T Legal Department - Moazzam;Attn: Patent Docketing, Room 2A-207, One AT&T Way, Bedminster, NJ, 07921, US

(73) Assignee: AT&T Mobility II LLC, Atlanta, GA (US)

(21) Appl. No.: 12/335,468

(22) Filed: Dec. 15, 2008

(51) Int. Cl. H04M 11/00; H04M 3/16

(52) U.S. Cl. 455/406; 455/410

(57) ABSTRACT

Devices, systems and methods are disclosed which relate to a visually distinct and tamper-resistant wireless telephone and a system for issuing the telephone, validating a call, and monitoring the call. This solution uses a durable wireless telephone design. Prepaid correctional wireless telephones are issued to inmates at correctional facilities. A system restricts calling to a centralized call control platform and performs validation, call detail data collection and storage, security, and ancillary features. The call detail data collection and storage is used for records and auditing purposes. Ancillary features include recording, three-way call detection, etc. A method is employed which validates a user's call and monitors the contents for security.

### BACKGROUND OF THE INVENTION

1. Field of the Invention

The present invention relates to wireless telephone service. More specifically, the present invention relates to wireless telephones and systems for validating, placing and monitoring calls.

2. Background of the Invention

Service providers provide pay-phone services at correctional facilities. These services allow inmates to make collect calls from a pay phone to their loved ones and family members. Four options exist presently to pay for correctional calls: collect, debit, prepaid cards, and advance pay or prepaid collect. The bad debt associated with correctional collect calling generally continues to exceed 30%. Service providers for correctional facilities have implemented use of debit, prepaid card, and advance pay solutions to manage bad debt. These debit, prepaid card, and advance pay solutions are generally dependent upon outside vendor services.

As technology has advanced, service providers have partnered with a number of different companies to control the calling patterns of inmates and work with law enforcement to provide them services related to those calls. Existing services include recording of calls, blocking calls to certain numbers, preventing the inmate from calling a friend who would then use three-way calling to reach out to another party who might be unauthorized for that person to call, etc.

The existing technology in correctional facilities is wire-line or VoIP based and requires a great deal of infrastructure at the facility. The existing technology requires technology platforms at the correctional facility or centrally located that are used to record the calls and provide all of the blocking and other items that are related to the requirements of the correctional facility. With the existing infrastructure comes a great cost to maintain the equipment at the site, to maintain the infrastructure, to provide a special location at the correctional facility to handle many or all of the call controls, and provide for the platform that handles call controls.

Existing pay phones that inmates use are similar to those seen on city streets, modified somewhat such that they do not have a coin box. The design is generally such that the telephone is on the wall with a corded handset. Some exceptions are present, including a hands-free set. This hands-free set allows an inmate to use an on-the-wall device by talking into a microphone. In all instances, the current infrastructure is a hardware device that has to be placed within the cells, dayrooms, pods, or whatever location of the correctional facility that is available for the inmates to use the telephone. The situation requires the service provider technicians to travel to the site to work on the equipment. This is a huge security risk, it takes a lot of time, and it is very expensive.

Problems with network cable, house cable, telephone units, etc., require service at the actual site. For instance, if a telephone unit requires a repair, the telephone company or equipment provider must send a technician into the facility to make the repair. However, sending a technician into a correctional facility becomes a huge security issue, both for the technician and the facility. The technician's safety must be accounted for at all times and it may be necessary to move inmates from an area. Additionally, the facility must make sure that the technician does not leave any foreign objects.

What is needed is a solution to provide telephone service to inmates, along with necessary validation and call controls, without requiring on-site visits by technicians.

### SUMMARY OF THE INVENTION

The present invention is a visually distinct and tamper-resistant wireless telephone and a system for issuing the telephone, validating a call, and monitoring the call. This solution uses a durable wireless telephone design. Prepaid correctional wireless telephones are issued to inmates at correctional facilities. A system restricts calling to a centralized call control platform and performs validation, call detail data collection and storage, security, and ancillary features. The call detail data collection and storage is used for records and auditing purposes. Ancillary features include recording, three-way call detection, etc. A method is employed which validates a user's call and monitors the contents for security.

In one exemplary embodiment, the present invention is a wireless communication system. The wireless communication system includes a visually distinct and tamper-resistant wireless telephone, a call control platform in communication with the telephone, a database in communication with the call control platform, and a call control logic onboard the call control platform. A call is validated by the call control logic prior to allowance then monitored and recorded into the database.

In another exemplary embodiment, the present invention is a wireless communication system. The wireless communication system includes a wireless telephone, a call control platform in communication with the telephone, a database in communication with the call control platform, and a call control logic onboard the call control platform. A call is validated by the call control logic prior to allowance then monitored and recorded into the database.

In a further exemplary embodiment, the present invention is a method of controlling wireless communication. The method of controlling wireless communication includes receiving a call attempt from a wireless telephone at a call control platform in communication with the telephone, validating the call attempt, allowing a call based on the call attempt, and monitoring the call. The call attempt is received and validated by a call control platform, prior to allowing the call.

In yet another embodiment, the present invention is a software program stored on a computer readable medium for controlling wireless communication. The software program includes a first code segment for receiving a call attempt from the wireless telephone at a call control center in communication with the telephone, a second code segment for validating the call attempt, a third code segment for allowing a call based on the call attempt, and a fourth code segment for monitoring the call. The call attempt is received and validated by a call control platform, prior to allowing the call, and then the call is monitored and recorded into a database.

### BRIEF DESCRIPTION OF THE DRAWINGS

FIG. 1 shows a wireless telephone for use in a correctional facility, according to an exemplary embodiment of the present invention.

FIG. 2 shows an example of a charging bank, according to an exemplary embodiment of the present invention.

FIG. 3 shows a system for wireless service in a correctional facility, according to an exemplary embodiment of the present invention.

FIG. 4 shows a flowchart of a correctional facility telephone service, according to an exemplary embodiment of the present invention.

FIG. 5 shows a flowchart of the process of the call control platform during a call attempt, according to an exemplary embodiment of the present invention.

### DETAILED DESCRIPTION OF THE INVENTION

The present invention is a visually distinct and tamper-resistant wireless telephone and a system for issuing the telephone, validating a call, and monitoring the call. This solution uses a durable wireless telephone design. Prepaid correctional wireless telephones are issued to inmates at correctional facilities. A system restricts calling to a centralized call control platform and performs validation, call detail data collection and storage, security, and ancillary features. The call detail data collection and storage is used for records and auditing purposes. Ancillary features include recording, three-way call detection, etc. A method is employed which validates a user's call and monitors the contents for security.

“Wireless telephone,” as used herein and throughout this disclosure, refers to a device capable of voice transmission and reception through a wireless connection. Examples of a wireless telephone include a cellular telephone, a cordless telephone, a personal digital assistant (PDA) employing voice transmission software, etc.

For the following description, it can be assumed that most correspondingly labeled structures across the figures (e.g., 132 and 232, etc.) possess the same characteristics and are subject to the same structure and function. If there is a difference between correspondingly labeled elements that is not pointed out, and this difference results in a non-corresponding structure or function of an element for a particular embodiment, then that conflicting description given for that particular embodiment shall govern.

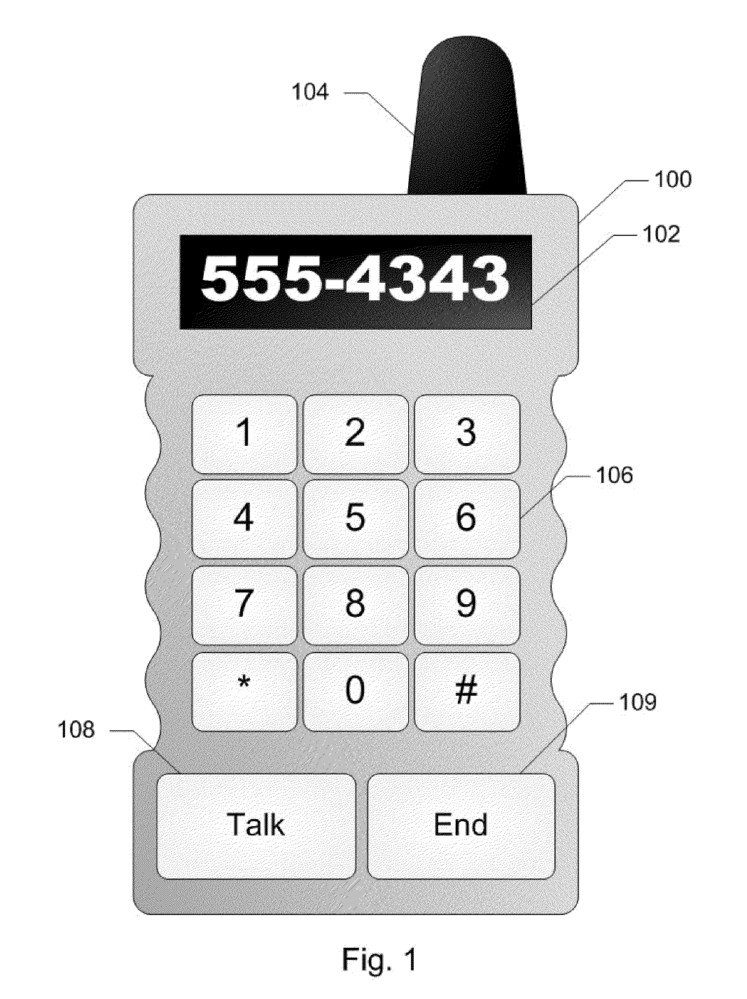

The disclosed wireless system relies upon inmates using wireless telephones. These wireless telephones may be given to each inmate such that they remain with the inmate, or attached to a wall, cell, etc. to remain in a single location. In embodiments where inmates are each given their own wireless telephones, each wireless telephone is durable and distinct. These characteristics allow for wireless telephones that have been smuggled into a facility to be easily spotted. The durability provides for long lasting use. An embodiment of a wireless telephone is shown in FIG. 1.

FIG. 1 shows a wireless telephone 100 for use in a correctional facility, according to an exemplary embodiment of the present invention. In this embodiment, wireless telephone 100 includes a display 102, an antenna 104, a keypad 106, a talk button 108, and an end button 109. Wireless telephone 100 design is durable enough for the prison population, yet inexpensive to produce and replace. For example, the housing of wireless telephone 100 is made of a hard plastic or rubber material to prevent wireless telephone 100 from breaking. Wireless telephone 100's design must be fitted such that neither wireless telephone 100 nor any of its internal components may be used as a weapon. In embodiments of the present invention, this is accomplished by using materials without sharp edges or materials that are not easily sharpened. Wireless telephone 100 is also constructed such that it is very difficult to pry apart. This prevents inmates from taking out any internal components, sharp or otherwise. The materials and durability of wireless telephone 100 ensure that it cannot foreseeably be used in any way to harm another person. Wireless telephone 100 does not have any sizeable crevices that may hold contraband.

In other exemplary embodiments, the housing of the wireless telephone is constructed using rivets instead of screws so that it cannot be easily pried apart. The housing could also snap together in a fashion preventing it from being opened without the use of a custom tool. Embodiments of the housing should be light in weight so that an inmate cannot use it as a weapon via its sheer weight. If a correctional facility insists upon having a metal housing, a rubber covering can serve as protection.

Wireless telephone 100's design is unique to differentiate it from any other wireless telephones to ensure wireless telephone smuggling into facilities is not promoted by wireless telephone 100's use. For example, wireless telephone 100 is bulky and is a certain distinct color, such as bright orange. Wireless telephone 100 is large enough for correctional facility personnel to see when it is in use.

Keypad 106 allows a user to enter numbers in order to place a call. Once the numbers are entered, the user presses talk button 108 to place the call. Display 102 allows a user to view a number being dialed. Display 102 may also allow the user to view an incoming number or caller ID, if an incoming capability is enabled. When the user has completed the call, the user presses end button 109 to end the call. Antenna 104 provides for the transmission and reception of cellular signals. This allows wireless telephone 100 to communicate with the network. Antenna 104 is preferably a material that is not easily sharpened or antenna 104 may be within the housing of wireless telephone 100, thereby reducing the possibility of using wireless telephone 100 as a weapon.

In exemplary embodiments of the present invention, a user is required to enter a Prisoner Identification Number (PIN) or other form of identification before placing a call. A PIN requirement may help discourage theft of wireless telephones from prisoners or the use of wireless telephones for bartering. These identifications may be periodically changed to preclude use of lost or stolen wireless telephones.

Wireless telephones must be rechargeable such that they may be used without replacing batteries or connecting to a wired network. Therefore, a “charging bank” or similar device is necessary to charge mass numbers of wireless telephones. Collecting wireless telephones to charge allows a facility to determine whether wireless telephones have been lost or stolen. Lost or stolen phones may be disabled such that they are not used improperly. This may be accomplished by removing a wireless telephone's ID from the network.

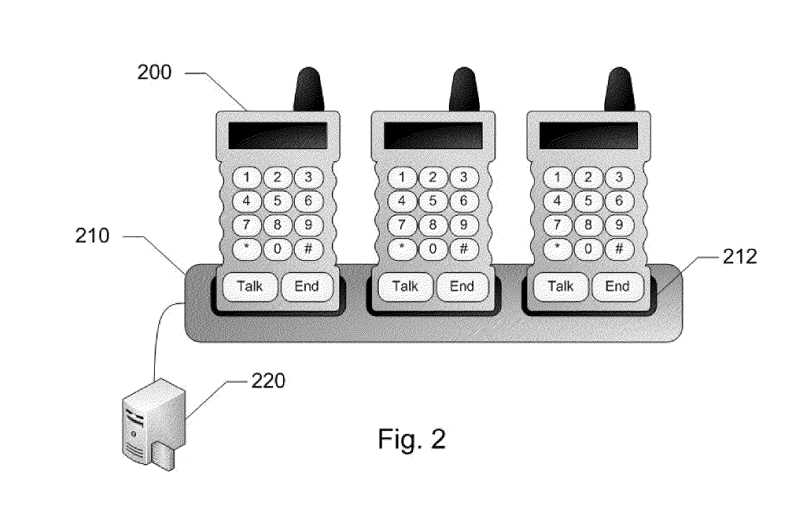

FIG. 2 shows a charging bank 210, according to an exemplary embodiment of the present invention. In this embodiment, charging bank 210 comprises a port 212 which receives a wireless telephone 200 in order to recharge wireless telephone 200. Charging bank 210 is in communication with a server 220. This communication may be wired or wireless. Server 220 may program or reprogram wireless telephone 200 in order to add or maintain necessary software. Additionally, in exemplary embodiments of the present invention, server 220 detects whether any attempts have been made to change the software on wireless telephone 200. This provides a safeguard to make sure wireless telephone 200 has not been reprogrammed for unauthorized use. Wireless telephones may all be collected at certain times in order to charge and/or program the wireless telephones.

In giving durable and distinct wireless telephones to inmates, a system is necessary to control the use of these devices. In environments such as a correctional facility, calls must be verified and screened to prevent unauthorized uses and often recorded for records purposes. Many other aspects of the call, such as the number and time of the call, must also be recorded and stored.

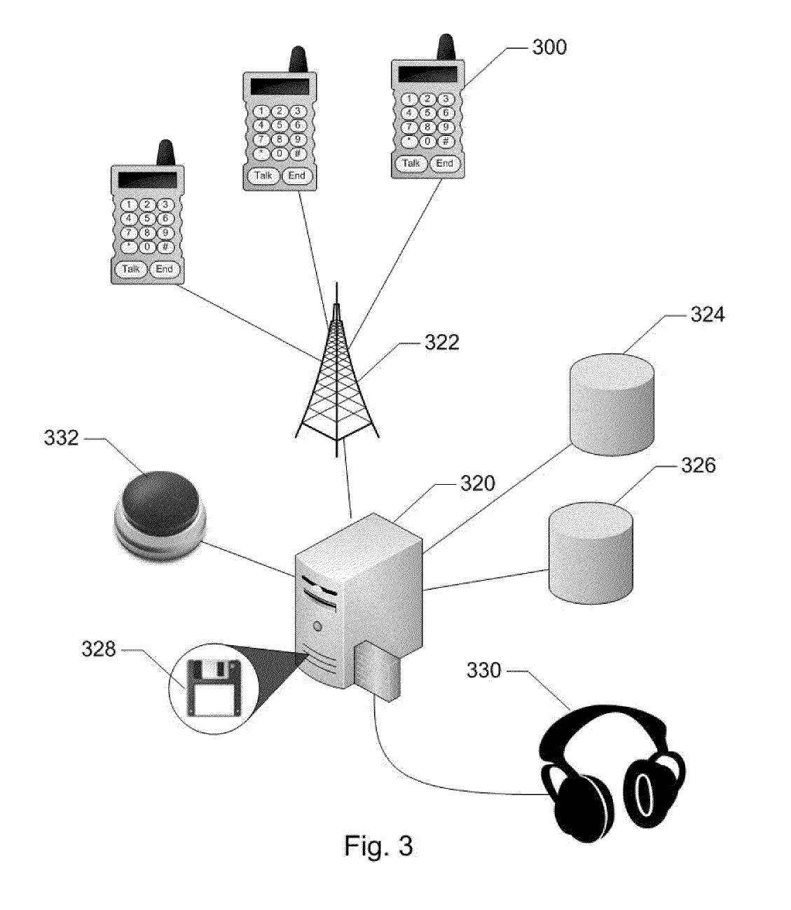

FIG. 3 shows a system for wireless service in a correctional facility, according to an exemplary embodiment of the present invention. In this embodiment, the system includes a wireless telephone 300, a cellular tower 322, a call control platform 320, logic 328 onboard call control platform 320, a call records database 324, a validation database 326, a call screening device 330, and a kill button 332. When a user places a call on wireless telephone 300, the transmission is routed through cellular tower 322 to call control platform 320. Cellular tower 322 may be either inside of or outside of the correctional facility, depending upon the signal strength needed, the frequency used for the system, etc. Calls in a correctional facility must be properly screened and often recorded. Before a dialed number is allowed, the call recipient often must be screened. Call control logic 328 does not allow any calls until the call has been validated. In other words, every call is blocked until logic 328 finds a reason to allow the call. Calls from inmates are only allowed to certain recipients, such as those wishing to accept a call from that inmate. Call control platform 320 records and stores call detail records into call records database 324. Call control platform 320 and call records database 324 manage and maintain recordings of all calls in the system. When a new number is dialed that has not been previously validated, an official at the facility dials the number to receive permission from the recipient and determine whether the recipient is one who may receive calls from the inmate in question. If the number is to be allowed, validation database 326 stores telephone numbers as an accepted number for the particular wireless telephone or user along with other numbers that have already been validated. If the number is not allowed, such as when the recipient does not wish to receive calls, the number is added to a blocked numbers file for that user. Logic 328 searches and updates validation database 326 as calls are placed. Logic 328 may be programmed with certain times a user is allowed to use wireless telephones. These times may be for every user of the system or for individual users. Additionally, logic 328 may potentially identify and block any attempt at three-way calling. This may be accomplished by disabling the connection to the receiving party.

Often, a correctional officer may wish to screen calls from inmates. Because all calls are routed through call control platform 320, officials may listen in using call screening device 330. Call screening device 330 may be headphones, a computer, etc. Correctional officers may also listen to calls stored in call records database 324. While listening to a call, an official may determine that a call is unauthorized. In this occurrence, a correctional officer may use kill button 332 to disconnect the call. Additionally, kill button 332 may be used to shut down the entire system. Kill button 332 may be a button or command and may be internal or external to call screening device 330.

In other exemplary embodiments the database stores all of the call detail including where the inmate calls from, where the inmate calls, the length of the call, etc. These call details can be kept in a centralized location so information can be analyzed and provided back to law enforcement personnel so they can determine what kind of calling activity is occurring.

In exemplary embodiments of the present invention, an existing central platform may be used. Inmate service providers today have centralized platforms that may be direct dialed from the cellular service to perform security and controls. This existing infrastructure may be manipulated for use in the present invention.

In further embodiments of the present invention, the validation of dialed numbers may be accomplished through an automated system on the server. When a number is dialed, the call control platform receives the request. The server dials the number and prompts the recipient to choose whether or not to accept the call. This may be accomplished by pressing a number, making a verbal statement, etc.

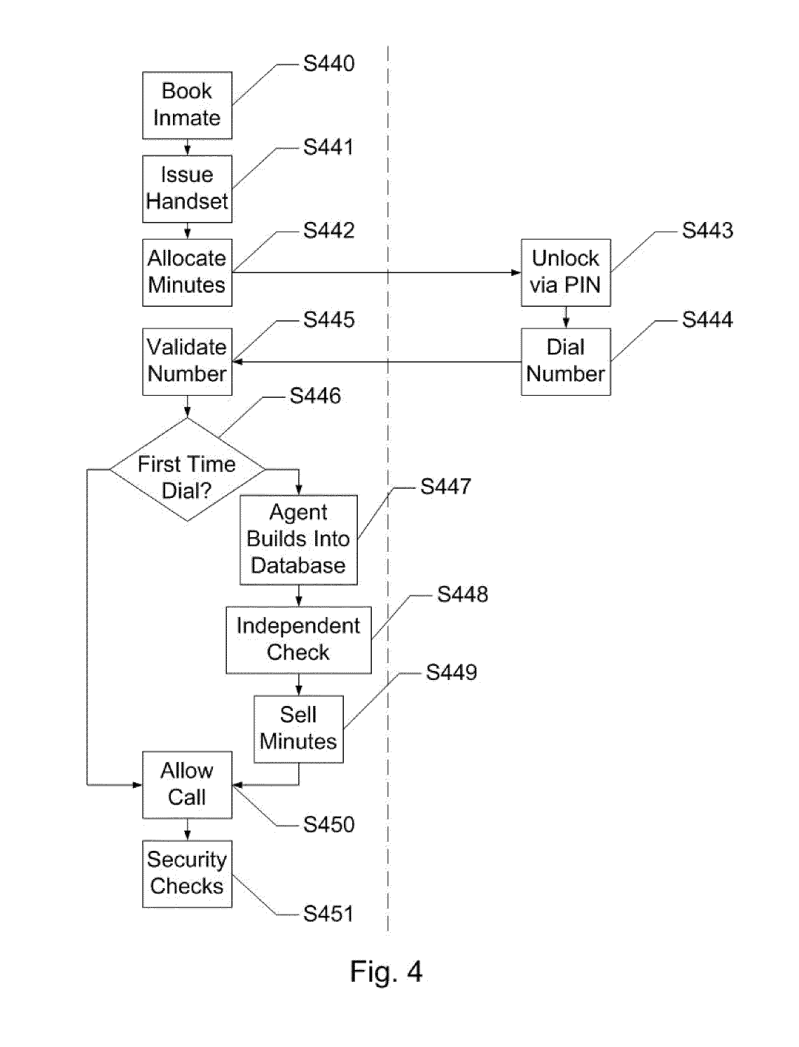

FIG. 4 shows a flowchart of a correctional facility telephone service, according to an exemplary embodiment of the present invention. In this embodiment, each inmate is booked at processing S440. During booking, information is provided detailing the means of communications. This calling information is provided along with the issuance of a correctional wireless telephone S441. Each wireless telephone is allocated a number of minutes S442. The number of minutes allocated may depend upon an amount paid by the inmate, an amount given to each inmate, an amount given by a third party, etc. The wireless telephones may be loaded with a negotiable number of minutes to allow at least one call during the booking procedure. Literature given to inmates at booking clarifies that once the minutes are depleted, no further calls are possible until additional minutes are purchased. This new paradigm may be marketed in the facilities' community to introduce the concept. Parties outside the facility may contact a centralized call processing department to purchase/add minutes to the wireless telephones. Inmates may also have the option to purchase minutes via commissary. The inmate “unlocks” the wireless telephone via a PIN assigned by the facility S443. The inmate may dial a number to which he wishes to connect S444. Connection to the call control platform may be stored and forwarded, or dialing any number may connect the inmate to the central server where the number dialed is validated to determine if the number that number is blocked in the database S445. For instance, facility personnel numbers, victim numbers, etc. are programmed at the switch of the call control platform, prohibiting calls to these numbers. If the number is not blocked, the system queries whether it is the first time the number has been dialed from this PIN/wireless telephone S446. An agent builds the number into the database, while requesting and entering customer information S447. For added security, an independent check, such as an outbound call to the number in question, is dialed to confirm the party is interested in receiving calls S448. During this independent check, the agent may solicit for funds for the inmate in question S449. If the number is approved, the information, including telephone number, name, address, etc., is built into the database, and calls may continue until minutes are depleted S450. If the call is not the first time the number has been dialed, the call is allowed as well S450. Security checks are put in place for calls from the wireless telephone S451. A limited number of eligible numbers may be defined for each wireless telephone or PIN. Facility personnel and investigators access the secure information from the centralized database via secure hyper text transfer protocol (HTTPS). Call information is captured and stored at the centralized switch for the period of time contractually agreed.

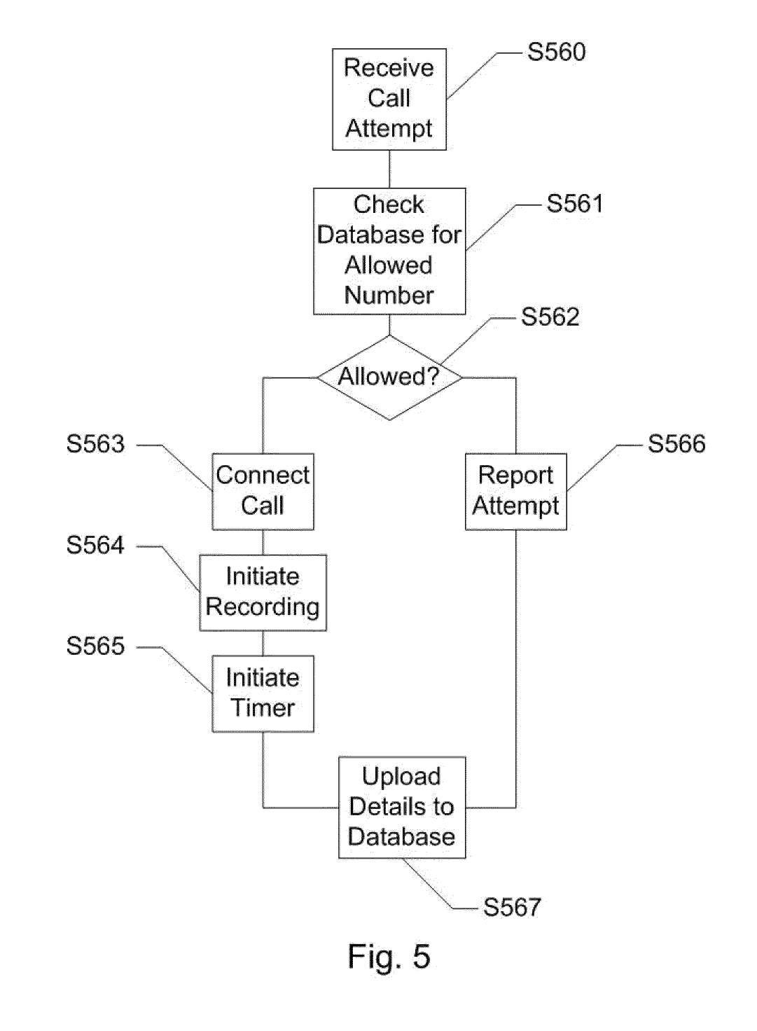

FIG. 5 shows a flowchart of the process of the call control platform during a call attempt, according to an exemplary embodiment of the present invention. In this embodiment, the call control platform receives the call attempt S560. Logic onboard the server checks a verification database for allowed numbers for the wireless telephone placing the call S561. Based upon the information in the verification database, the server queries whether the call is allowed to the intended recipient S562. If the call is allowed, the call is connected S563. The connection of the call may initiate a recording of the call by the call control platform S564. The connection of the call also initiates a timer to determine the length of the call S565. This time will be deducted from the wireless telephone's number of available minutes. The recording of the call as well as the time of the call is uploaded to a call detail database S567. If the call is not allowed, the attempted call is reported S566. This report may be directly to facility personnel, such as by e-mail, text message, etc. The report is additionally uploaded to the call detail database S567.

While some may believe cellular phones in the corrections environment impose a security threat, the present invention increases security. In embodiments of the invention, the invention incorporates what is similar to a closed Prisoner Identification Number (PIN) system. Only numbers programmed into the central server may be called from any of the wireless telephones. This concept increases visibility to investigators of what numbers are being dialed by the inmates. It also affords the ability to build a mining database of numbers and information being called from the phones, simplifying investigations. It is critical that other correctional cell phones may never be called by any of these wireless telephones.

In embodiments of the present invention, the signal frequency for the cellular service is unique from other cellular frequencies. Outside frequencies may be blocked or are too weak to be used. Together, this discourages the smuggling of other cellular telephones into the facility because they are useless.

The disclosed system substantially eliminates a service provider's need to visit a facility, reducing operation expenses. These operating expenses are a significant and service impacting issue fielded by all providers today. The system also substantially eliminates cable and wiring at facilities, which is often house cable, or old dilapidated telco cable. The system additionally eliminates collect calling and Advance Pay, which helps eliminate bad debt. The system allows for rate flexibility, and reduces and simplifies billing expenses.

Local police or other groups can have access to the same security features that are referenced herein. This design needs to be dynamic enough to be provisioned for a large or small facility. The centralized call control platform manages the data, the recordings, and the call details. The centralized call control platform may be used in any environment where only specified numbers are to be dialed, calls need to be recorded, call details need to be recorded, etc. For example, embodiments of the invention may be used by a police force in a localized area or by workers on an oil rig. The same methodology as described above for the example of a correctional facility may be applicable to such other environment and uses. These embodiments may use any type of wireless telephone, but basics of the centralized call control platform remain the same.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A wireless communication system comprising:
a visually distinct and tamper-resistant wireless telephone;
a call control platform in communication with the telephone;
a database in communication with the call control platform; and
a call control logic onboard the call control platform;
wherein a call is validated by the call control logic prior to allowance then monitored and recorded into the database.

2. The system in claim 1, wherein the database stores a plurality of call recordings.

3. The system in claim 1, wherein the database stores a plurality of telephone numbers belonging to willing recipients.

4. The system in claim 1, wherein the call control platform detects three-way calling.

5. The system in claim 4, wherein the call control platform ends a call wherein a three-way call has been initiated.

6. The system in claim 1, wherein the call control platform stops all calls upon an event.

7. The system in claim 1, wherein the call control platform is in a remote location relative to the wireless telephone.

8. The system in claim 1, wherein the contents of the database are viewable remotely through a device in communication with the database.

9. The system in claim 1, wherein the database contains a plurality of pre-paid accounts.

10. The system in claim 9, wherein each pre-paid account corresponds to a user.

11. A wireless communication system comprising:
a wireless telephone;
a call control platform in communication with the telephone;
a database in communication with the call control platform;
a call control logic onboard the call control platform;
wherein a call is validated by the call control logic prior to allowance then monitored and recorded into the database.

12. The system in claim 11, wherein the wireless telephone is visually distinct.

13. The system in claim 11, wherein the wireless telephone is tamper-resistant.

14. A method of controlling wireless communication comprising:
receiving a call attempt from a wireless telephone at a call control platform in communication with the telephone;
validating the call attempt;
allowing a call based on the call attempt; and
monitoring the call;
wherein the call attempt is received and validated by a call control platform, prior to allowing the call.

15. The method in claim 14, further comprising issuing the wireless telephone.

16. The method in claim 14, wherein the validating comprises blocking the call attempt until finding a reason to allow the call.

17. The method in claim 14, further comprising recording the call.

18. The method in claim 14, further comprising storing the call on the database.

19. The method in claim 14, wherein the validating further comprises ensuring a call recipient is willing to receive the call.

20. The method of claim 19, wherein the ensuring is accomplished using an automated call.

21. The method in claim 14, wherein the validating further comprises ensuring a pre-paid account has enough funds.

22. A software program stored on a computer readable medium for controlling wireless communication comprising:
a first code segment for receiving a call attempt from the wireless telephone at a call control center in communication with the telephone;
a second code segment for validating the call attempt;
a third code segment for allowing a call based on the call attempt; and
a fourth code segment for monitoring the call;
wherein the call attempt is received and validated by a call control platform, prior to allowing the call, then the call is monitored and recorded into a database.
